(19) United States
(12) Patent Application Publication
(10) Pub. No.: US 2010/0075719 A1
(43) Pub. Date: Mar. 25, 2010

(54) CELLULAR PHONE

(76) Inventors: Taizo TOMIOKA, Yokohama-shi (JP); Naotake Watanabe, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/560,820

(22) Filed: Sep. 16, 2009

(30) Foreign Application Priority Data
Sep. 25, 2008 (JP) 2008-245086

(51) Int. Cl. H04M 1/00; H04B 1/38

(52) U.S. Cl. 455/566; 455/575.1

(57) ABSTRACT

An example of the present invention is a cellular phone including, a plate-like portion of a metallic material having at least one of a display section and an input key unit located on one principal surface side thereof, and a frame side portion including a frame-like elongated member of an insulating material and disposed at an outer peripheral part of the plate-like portion, a dimension of the elongated member constituting the frame side portion in a thickness direction intersecting the principal surface being smaller than a dimension of the elongated member in a width direction intersecting the thickness direction.

### CROSS-REFERENCE TO RELATED APPLICATIONS

This application is based upon and claims the benefit of priority from prior Japanese Patent Application No. 2008-245086, filed Sep. 25, 2008, the entire contents of which are incorporated herein by reference.

### BACKGROUND OF THE INVENTION

1. Field of the Invention

The present invention relates to a cellular phone, and more specifically, to a cellular phone capable of being made smaller and thinner.

2. Description of the Related Art

A candy-bar cellphone is a known example of a cellular phone, in which various components, such as a display, input key unit, motherboard, battery, microphone, and receiver, are contained in one case or housing (e.g., Jpn. Pat. Appln. KOKAI Publication No. 2008-147407).

In a candy-bar cellular phone 100 shown in FIG. 14, for example, a case 101 is a box formed by combining upper and lower boxes 102 and 103, which each have a bottom wall and sidewalls. Each of the upper and lower boxes is formed into a predetermined shape by resin molding or the like. The case 101 is configured to contain various components, such as a display 104, input key unit 105, motherboard 106, battery 107, microphone 108, and receiver 109. In order to obtain reaction force during a key input operation, in this cellular phone 100, a metal plate 110 is located on the reverse side of the input key unit 105.

On the other hand, a clamshell cellular phone is also known in which a first case that contains an input key unit and battery and a second case that contains a display and components are arranged in a folding manner with a hinge part between them (e.g., Jpn. Pat. Appln. KOKAI Publication No. 11-298158).

In this clamshell cellular phone, each case is formed by, for example, adhesively bonding a stainless-steel plate and magnesium housing to each other. An alternative configuration example is known in which a first case integrally formed of a stainless-steel plate and resin is combined with a plastic second case.

There is a strong demand for smaller, thinner cellular phones that are more portable. These phones, having the components contained in the case or housing, can be made smaller or thinner by reducing the wall thickness of the case.

However, the above technique has the following problem. If the wall thickness of the plastic housing is simply reduced, the strength of the housing is also reduced.

### BRIEF SUMMARY OF THE INVENTION

According to an aspect of the present invention, a cellular phone comprises, a plate-like portion of a metallic material having one of a display section and an input key unit located on one principal surface side thereof, and a frame side portion including a frame-like elongated member of an insulating material and disposed at an outer peripheral part of the plate-like portion, a dimension of the elongated member constituting the frame side portion in a thickness direction intersecting the principal surface being smaller than a dimension of the elongated member in a width direction intersecting the thickness direction.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view showing a cellular phone according to a first embodiment of the invention;

FIG. 2 is an exploded perspective view showing the cellular phone;

FIG. 3 is a plan view of the cellular phone;

FIG. 4 is a view illustrating the structure of the cellular phone;

FIG. 5 is a perspective view showing the structure of a base section of the cellular phone;

FIG. 6 is a view illustrating a manufacturing process for the cellular phone;

FIG. 7 is a view illustrating a manufacturing process for the cellular phone;

FIG. 8 is a view illustrating a manufacturing process for the cellular phone;

FIG. 9 is a perspective view showing a base section of a cellular phone according to a second embodiment of the invention;

FIG. 10 is a sectional view of the base section;

FIG. 11 is a sectional view showing a plate-like portion according to the second embodiment;

FIG. 12 is a perspective view showing a base section of a cellular phone according to a third embodiment of the invention;

FIG. 13 is a sectional view of the base section;

FIG. 14 is a view illustrating an example of a cellular phone; and

FIG. 15 is a view illustrating an example of a cellular phone.

### DETAILED DESCRIPTION OF THE INVENTION

### First Embodiment

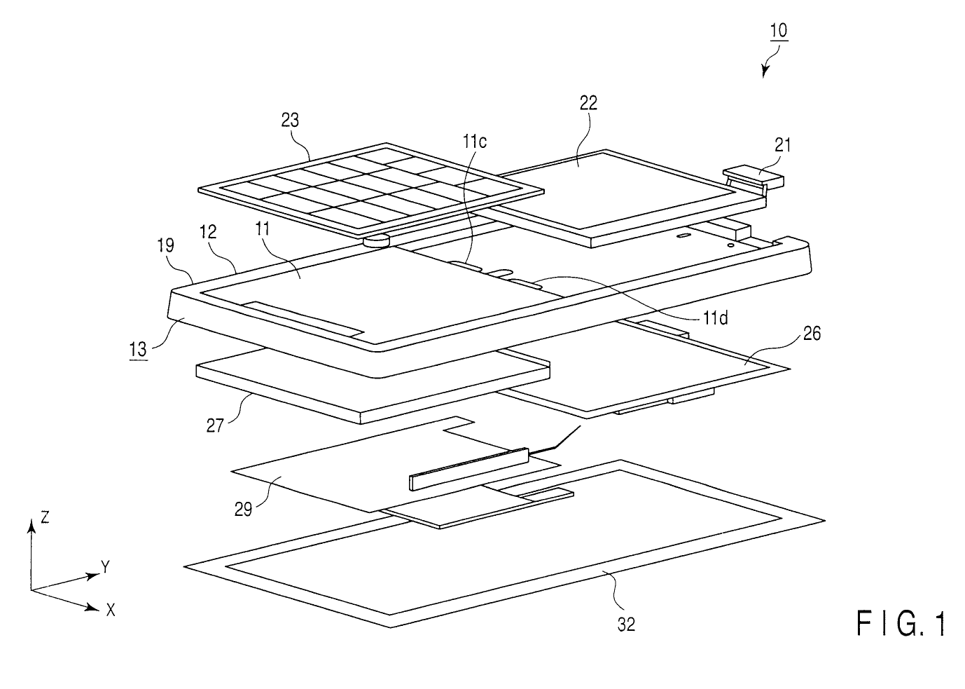

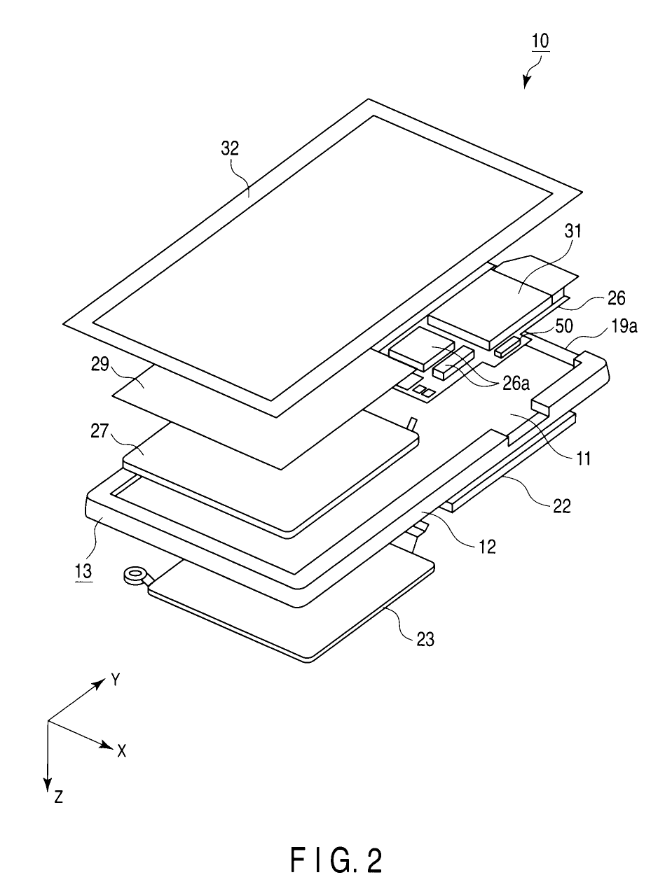

A first embodiment of the present invention will now be described with reference to FIGS. 1 to 4. In these drawings, arrows X, Y and Z individually indicate three orthogonal directions. In each of the drawings, some configurations are enlarged, reduced or omitted for ease of illustration.

A cellular phone 10 is a candy-bar cellphone in the form of a cuboid, measuring, for example, 50 mm wide, 90 mm long, and 4 mm thick.

The cellular phone 10 is provided with a base section 13, which is formed of a rectangular plate-like portion 11 and frame side portion 12 surrounding the outer periphery of the plate-like portion 11. Various components 20, such as a receiver 21, liquid crystal display (display section) 22, input key unit (input key section) 23, microphone 24, antenna 25, motherboard 26, and battery 27, are arranged in a region surrounded by the base section 13.

The plate-like portion 11 is located behind the input key unit 23 and is in the form of a rectangular plate of a metallic material, such as stainless steel, about 0.3 mm thick (in the Z-direction). The plate-like portion 11 produces reaction force during an input operation in which keys of the input key unit 23 are pressed.

A slot 11a through which a flexible wiring board for connecting the receiver 21 and motherboard 26 is passed is provided on one longitudinal end side of the plate-like portion 11, and a slot 11b for holding the antenna 25 is formed on the other end side.

The plate-like portion 11 is bent along its thickness at two spots in an intermediate portion with respect to the lengthwise direction (Y-direction) and is formed with a stepped portion 14 about 1 mm high. The stepped portion 14 divides a depressed portion 16 on one longitudinal side and a raised portion 15 on the other side. Thus, the difference in thickness between the liquid crystal display 22 and input key unit 23 can be absorbed to make the surface of the phone flat. Further, the stepped portion 14 extends in the crosswise direction (X-direction) of the phone and serves to enhance the rigidity of the phone along its short sides.

The stepped portion 14 is inclined with respect to the vertical direction, and two wiring slots 11c and 11d are formed penetrating the inclined portion across its thickness. The wiring slot 11c can be penetrated by wirings 17 and 18 that connect the components 20 arranged on one principal surface side (obverse side) and those arranged on the other principal surface side (reverse side).

The frame side portion 12 is formed of fiberglass-reinforced plastic containing, for example, a polyamide resin mixed with fiberglass. The frame side portion 12 includes elongated members 19 on its four sides that extend longitudinally and transversely across one another and form a frame.

Each elongated member 19 has a width (dimension in the X- or Y-direction) of 4 mm and a thickness (dimension in the Z-direction) of 3.5 mm, for example. The width of each elongated member 19 is not smaller than half of, or preferably equal to or greater than, its thickness. Preferably, moreover, the thickness of each elongated member 19 should be, for example, five or more times as great as the thickness of the plate-like portion 11.

A notched opening 19a through which an SIM connector 31 is exposed is formed in a predetermined region corresponding to a connector on the frame side portion 12.

A region surrounded by the frame side portion 12 is divided above and below (between the obverse and reverse sides) by the plate-like portion 11 and further divided lengthwise by the stepped portion 14. Thus, four spaces are defined around the stepped portion 14 of the plate-like portion 11. In FIG. 6, first, second, third, and fourth regions A1, A2, A3 and A4 are shown in the upper right, upper left, lower right, and lower left, respectively.

The receiver 21, the liquid crystal display 22, and a protective plastic film 28 are located in the first region A1.

The input key unit 23, microphone 24, and antenna 25 are located in the second region A2.

An RF-ID coil antenna 29 and motherboard 26 are located in the third region A3.

The battery 27 is located in the fourth region A4.

The receiver 21 is located on the obverse side of the phone and connected to the motherboard 26 by the flexible wiring board (not shown) passed through the slot 11a.

The liquid crystal display 22 is located on the obverse side of the phone, and the protective plastic film 28 0.1 mm thick is affixed to the surface of the display 22.

The input key unit 23 and microphone 24 are located on the obverse side of the phone and connected to each other by a flexible wiring board (not shown).

The antenna 25 is located through the slot 11b in the plate-like portion 11 and connected to the motherboard 26 through an antenna impedance matching circuit board (not shown).

The motherboard 26 is a rectangular plate 40 mm wide, 45 mm long, and 0.3 mm thick. An electronic component 26a such as a semiconductor package with a maximum thickness of 1.4 mm is mounted on the motherboard 26.

The RF-ID coil antenna 29, which is a flexible wiring board 0.1 mm thick, is connected to the motherboard 26, and is mounted on the motherboard 26.

The battery 27 is adhesively bonded to the plate-like portion 11 from behind the phone and connected to the motherboard 26 through a protection circuit.

The external connector 50 for charging and data transmission and reception is mounted on the motherboard 26 so as to be located in the opening 19a in the form of a notch in a short-side part.

The protective plastic film 28 is located on the surface of the liquid crystal display 22.

The reverse and obverse surfaces of the phone are respectively covered by plastic style strips 32 and 33 0.2 mm thick. The style strips 32 and 33 are bonded to the surfaces of the frame side portion 12 by 0.05-mm-thick adhesive films (not shown), individually.

Further, the liquid crystal display 22 and input key unit 23 are respectively connected to the motherboard 26 by flexible wiring boards 17 and 18 0.2 mm thick. The wiring boards 17 and 18 are arranged through the two slots 11c and 11d 10 mm by 0.8 mm in the stepped portion 14 of the plate-like portion 11.

Assembly procedures for the cellular phone 10 according to the present embodiment will now be described with reference to FIGS. 5 to 8 and 4.

The slots 11a to 11d are formed at four predetermined spots on the 0.3-mm-thick stainless-steel plate, and the stepped portion 14 is formed by bending the plate by means of a die. The plate-like portion 11 with a predetermined shape is formed in this manner.

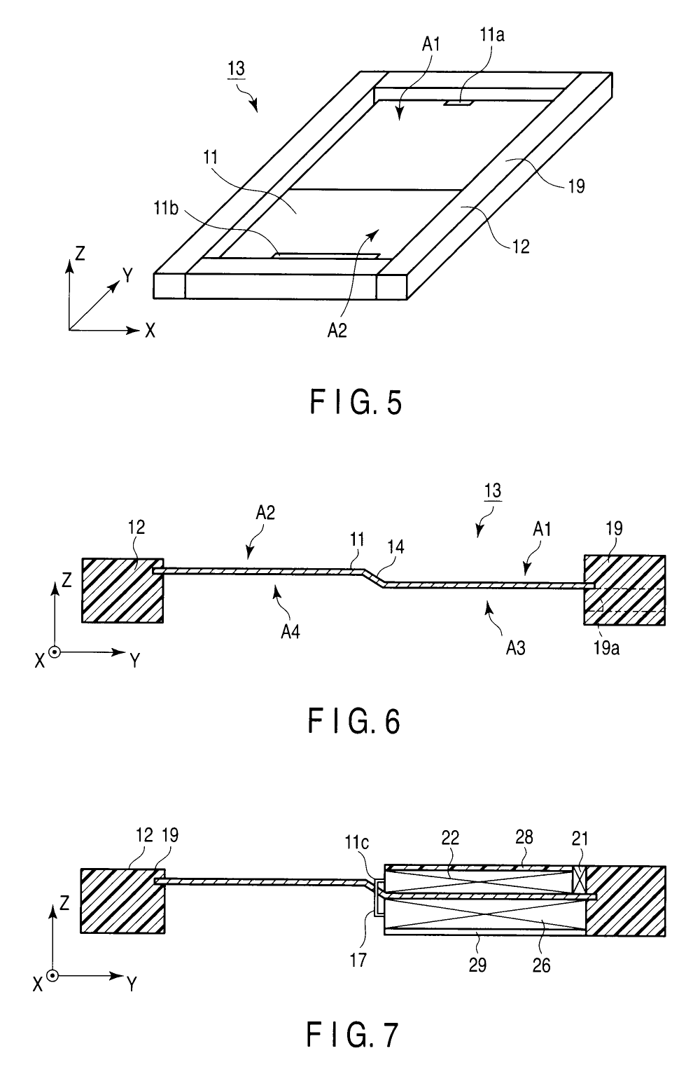

Then, the plate-like portion 11 is set in a resin molding die, and the base section 13 is formed by molding the plastic frame side portion 12 3.5 mm thick on the outer peripheral part of the plate-like portion 11 by the injection method. In this molding operation, the frame side portion 12 is formed into a frame of a predetermined shape with the notched opening 19a. The base section 13 shown in FIGS. 5 and 6 is constructed in this manner.

Then, the motherboard 26 mounted with the electronic component 26a, receiver 21, and liquid crystal display 22 are fixed to the frame side portion 12 of the base section 13, as shown in FIG. 7. These portions are fixed to the plate-like portion 11 by means of an adhesive sheet that is electrically insulative from the plate-like portion 11. Further, the elements are connected to one another by flexible wiring boards (not shown).

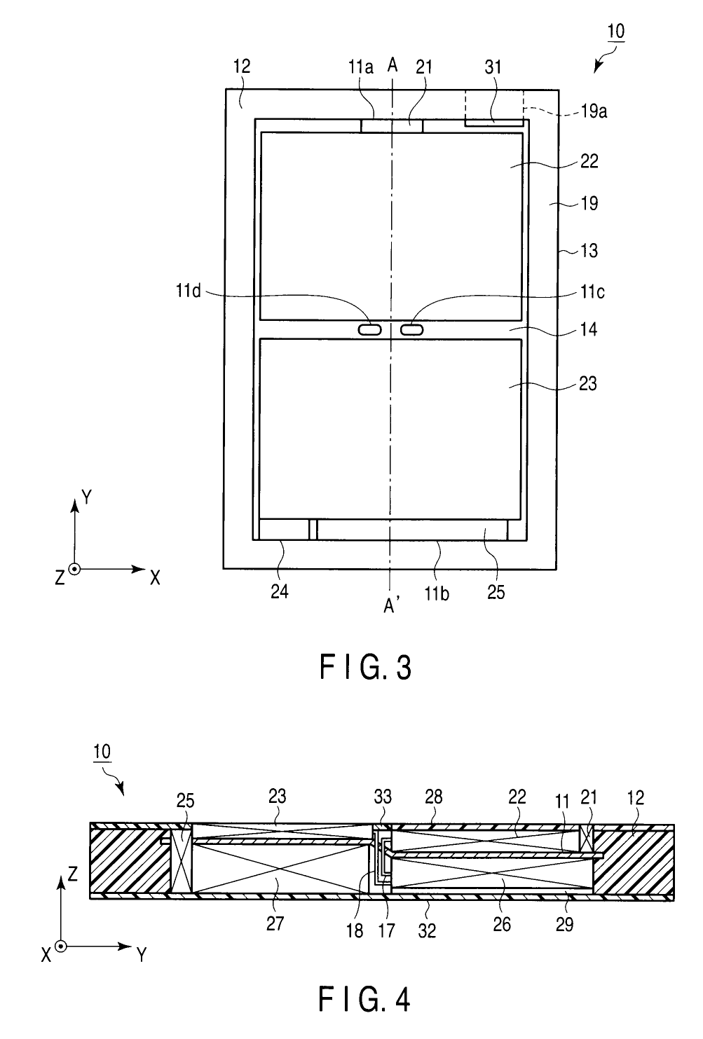

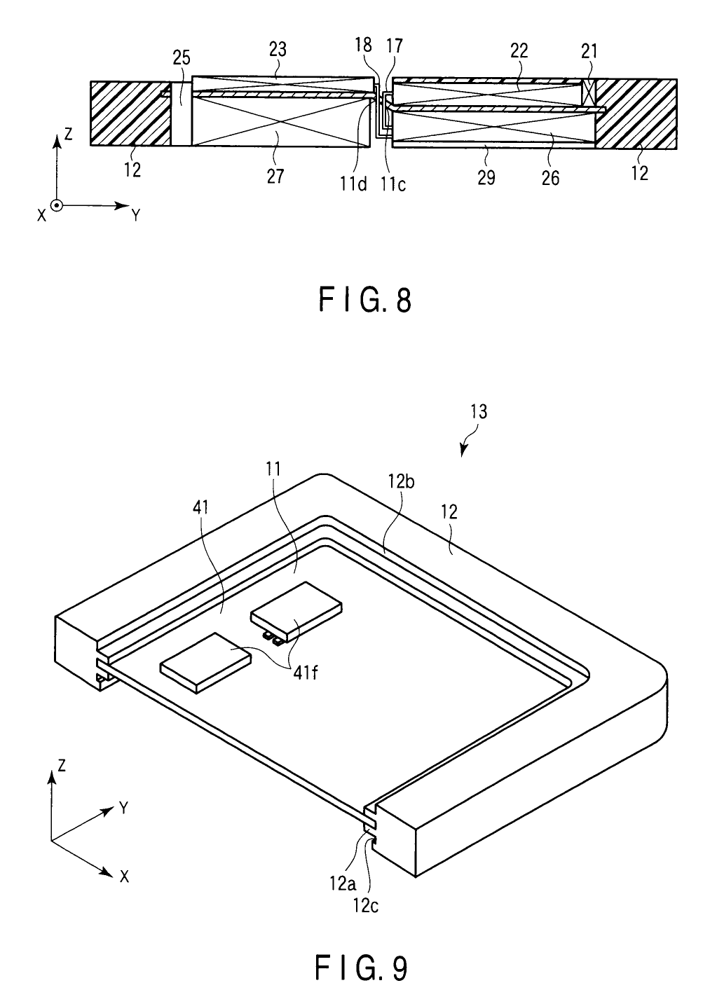

Then, as shown in FIG. 8, the input key unit 23 and microphone 24 (FIG. 3) are attached to the base section 13 from the obverse side of the phone, and the battery 27 from the reverse side.

Further, the antenna 25 is fixed through the slot lib. Finally, the style strips 32 and 33 are bonded to the reverse and obverse surfaces, respectively, of the phone, whereupon the phone is completed.

In this manner, the cellular phone 10 shown in FIGS. 1 to 4 is completed.

According to the present embodiment, the cellular phone can be made thinner while maintaining its rigidity. Thus, according to the cellular phone 10, its thickness can be reduced without failing to secure its essential strength, and radio frequency identification can be satisfactorily performed by using either of its surfaces. Since the frame side portion 12 and plate-like portion 11 are molded integrally with each other, moreover, the rigidity can be enhanced with a simple configuration.

Since the plate-like portion 11 has the slots 11a to 11d for component mounting, furthermore, there is no need of any mounting mechanism for positioning or fixing the components 20, so that the configuration can be simplified.

Since the frame side portion 12 of an insulating resin is used in the present embodiment, moreover, it can deal with communication such that an induced current is changed with a change of a magnetic flux that passes through the loop of the coil antenna 29 used for RF-ID communication. Specifically, if a metal body 113 exists between a coil antenna 111 and reader/writer 112 for identification, as shown in FIG. 15, an eddy current is produced in the metal body 113, and a demagnetizing field produced by the eddy current cancels a necessary magnetic field for the communication, so that a case 101 formed of the aforementioned metal cannot be used. However, this unfavorable situation can be avoided according to the present embodiment.

Although stainless steel is used for the plate-like portion 11 that constitutes the frame according to the present embodiment, it may be replaced with copper, nickel, or some other material with the same effect. Further, the material of the frame side portion 12 is not limited to a polyamide-based resin, and some other strong resin may be used instead. Furthermore, the reinforcement for the resin is not limited to fiberglass.

### Second Embodiment

A cellular phone 10 according to a second embodiment of the invention will now be described with reference to FIGS. 9 to 11. In these drawings, arrows X, Y and Z indicate three orthogonal directions, individually. In each of the drawings, some configurations are enlarged, reduced or omitted for ease of illustration. Since the second embodiment differs from the first embodiment only in that a plate-like portion 11 is a wiring board 41, a repeated description of other configurations is omitted.

In the present embodiment, the plate-like portion 11 is the wiring board 41 formed of a metal core, not a stainless-steel plate. A plastic frame side portion 12 is formed around the wiring board 41 and constitutes a base section 13. Thus, the number of components is reduced by using the wiring board 41 as the plate-like portion 11.

FIG. 9 is a partially cutaway perspective view showing an upper part of the base section 13 of the present embodiment. As shown in FIGS. 9 and 10, the frame side portion 12 has a substantially H-shaped cross section and integrally includes a holding portion 12a for holding the outer peripheral edge of the plate-like portion 11 and sidewall portions 12b and 12c extending individually on the opposite sides of the holding portion 12a with respect to its thickness. The sidewall portions 12b and 12c extend on the obverse and reverse sides, respectively. The wiring board 41 is combined with a housing that is provided with sidewalls of an insulating material thicker than the wiring board.

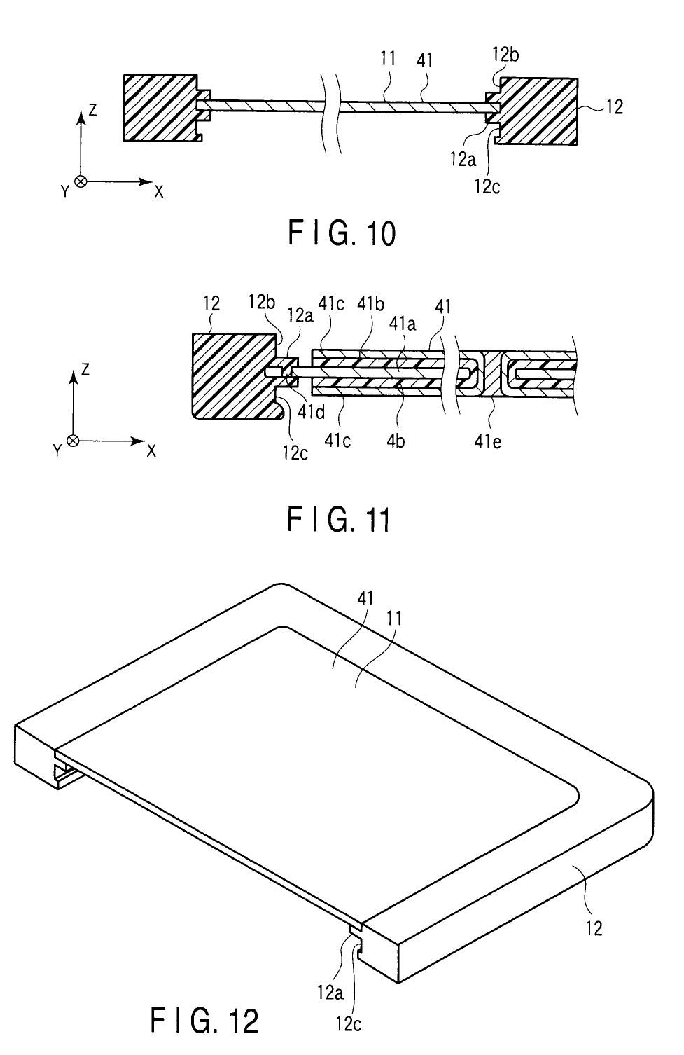

As shown in FIG. 11, the wiring board 41 as the plate-like portion 11 includes a stainless-steel core 41a, ABS resin layers 41b disposed individually on the obverse and reverse principal surfaces of the core, and copper wirings 41c formed individually on the ABS resin layers 41b. Through-holes 41e of an electrically conductive material are formed individually on predetermined regions of the wiring board 41. Each through-hole 41e penetrates the wiring board 41 from obverse to reverse and has its side surface formed with or is filled with a metal film of copper or the like.

Various components are mounted directly in predetermined regions on the wiring board 41. For example, the liquid crystal display 22 and keys are mounted on the wiring board 41, and an electronic component 41f, such as a semiconductor package, and battery 27 on the reverse side.

The metal core 41a is exposed at the outer peripheral part of the wiring board 41 and held by the frame side portion 12.

Further, a plurality of holding holes 41d are formed in the outer peripheral part of the plate-like portion 11, which is held by the holding portion 12a, so as to penetrate the peripheral part across its thickness. A resin material is molded so as to fill the holding holes 41d and cover the outer peripheral part, whereby the frame side portion 12 is formed. In other words, the frame side portion 12 is formed in such a manner that the resin material is integrally molded passing through the holding holes 41d. Thus, the plate-like portion 11 can be firmly held by the holding portion 12a.

The present embodiment can produce the same effects as those of the aforementioned first embodiment. Further, the total thickness of the cellular phone can be reduced by using the wiring board 41 as a substitute for the plate-like portion 11. Furthermore, functional unit components of electronic equipment divided by the plate-like portion 11 can be mounted directly, so that the number of components, including connectors, can be reduced. Since the frame side portion 12 and wiring board 41 on which the components are mounted are molded integrally with one another, moreover, the assembly of components can be facilitated.

### Third Embodiment

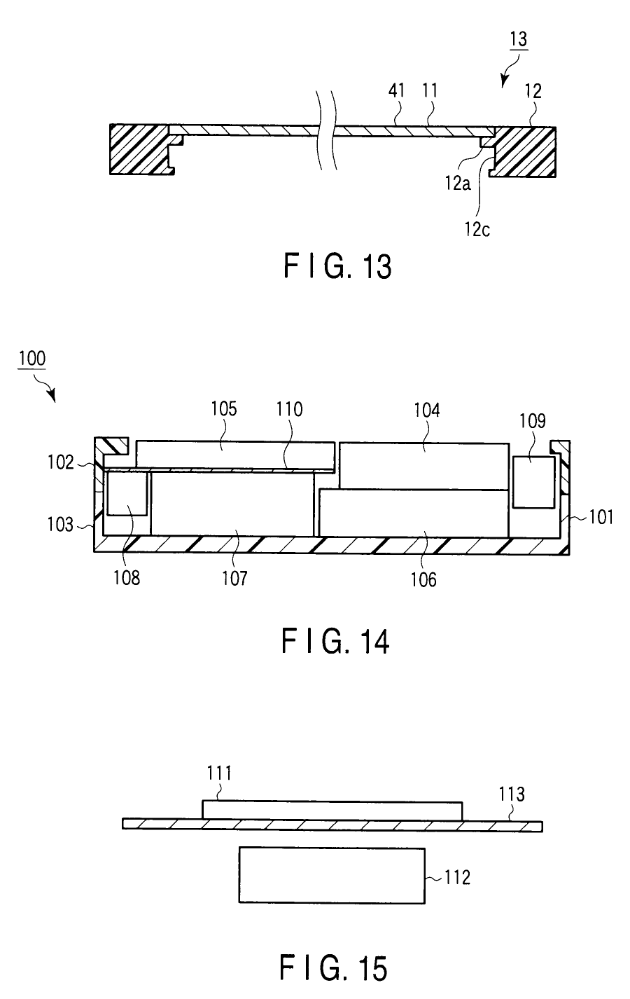

A cellular phone 10 according to a third embodiment of the invention will now be described with reference to FIGS. 12 to 13. In each of the drawings, some configurations are enlarged, reduced or omitted for ease of illustration. Since the third embodiment differs from the first and second embodiments only in that a sidewall portion is formed on one side only, a repeated description of other configurations is omitted.

FIG. 12 is a partially cutaway perspective view showing an upper part of a base section 13 of the present embodiment. According to the present embodiment, as shown in FIGS. 12 and 13, a frame side portion 12 has a substantially U-shaped cross section and integrally includes a holding portion 12a for holding the outer periphery of a plate-like portion 11 and a sidewall portion 12c extending on the reverse side of the holding portion 12a with respect to its thickness. Thus, no sidewall portion is formed on the obverse side. An electronic component 41f, such as a battery 27, is mounted in a region surrounded by the sidewall portion 12c on the reverse side and the reverse surface of the plate-like portion 11, and an input key unit 23 is laid on the upper surface of the plate-like portion 11.

The present embodiment can produce the same effects as those of the aforementioned first and second embodiments.

The present invention is not limited directly to the embodiments described above, and its constituent elements may be embodied in modified forms without departing from the spirit of the invention.

The frame side portion 12 may be configured to surround either the entire circumference or part of the plate-like portion 11.

Various inventions can be formed by appropriately combining a plurality of constituent elements described in connection with the embodiments described herein. For example, some of the constituent elements according to the embodiments may be omitted. Further, constituent elements according to different embodiments may be combined as required.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A cellular phone comprising:
a plate-like portion of a metallic material having at least one of a display section and an input key unit located on one principal surface side thereof; and
a frame side portion including a frame-like elongated member of an insulating material and disposed at an outer peripheral part of the plate-like portion,
a dimension of the elongated member constituting the frame side portion in a thickness direction intersecting the principal surface being smaller than a dimension of the elongated member in a width direction intersecting the thickness direction.

2. A cellular phone according to claim 1, wherein the cellular phone is of a candy-bar type such that the display section and the input key unit are arranged on the one principal surface side of the plate-like portion in a region surrounded by the frame side portion.

3. A cellular phone according to claim 1, wherein the plate-like portion is formed with an opening portion communicating with the one and the other surface sides, and a component contained on the one surface side and a component contained on the other surface side are electrically connected to each other by a wiring passed through the opening portion.

4. A cellular phone according to claim 1, wherein the plate-like portion is bent in the thickness direction to form a stepped portion, which extends across the cellular phone.

5. A cellular phone according to claim 1, wherein the plate-like portion is a wiring board, on which the components are mounted.

6. A cellular phone according to claim 1, wherein the frame side portion is molded integrally including a holding portion, which holds the outer periphery of the plate-like portion, and sidewall portions extending individually on the opposite sides of the holding portion with respect to the thickness direction at an outer peripheral part of the plate-like portion.

7. A cellular phone according to claim 1, wherein the frame side portion is molded integrally including a holding portion, which holds the outer periphery of the plate-like portion, and a sidewall portion extending on the one side of the holding portion with respect to the thickness direction at an outer peripheral part of the plate-like portion.

8. A cellular phone according to claim 1, wherein the plate-like portion is a wiring board including a metal core, which is exposed at an outer peripheral part of the plate-like portion, and the exposed metal core is held by the frame side portion.

9. A cellular phone according to claim 6, wherein the outer peripheral part of the plate-like portion held by the holding portion is formed with a hole which penetrates the outer peripheral part in the thickness direction, and the frame side portion is formed in such a manner that a synthetic resin material is molded so as to fill the hole and cover the outer peripheral part.
